(19) United States
(12) Patent Application Publication
(10) Pub. No.: US 2009/0290022 A1
(43) Pub. Date: Nov. 26, 2009

(54) SYSTEM AND METHOD FOR TRANSMITTING VIDEO OF ENTIRE LAW ENFORCEMENT PROCESSING

(75) Inventor: Hyun Duk UHM, Seoul (KR)

Correspondence Address: ADAM K. SACHAROFF;MUCH SHELIST DENENBERG AMENT & RUBENSTEIN, 191 N. WACKER DRIVE, Suite 1800, CHICAGO, IL, 60606-1615, US

(73) Assignee: ID. FONE CO., LTD., Seoul (KR)

(21) Appl. No.: 12/194,675

(22) Filed: Aug. 20, 2008

(30) Foreign Application Priority Data
May 21, 2008 (KR) 10-2008-0047157

(51) Int. Cl. H04N 7/18

(52) U.S. Cl. 348/148; 348/E07.085

(57) ABSTRACT

The present invention relates to a system and method for transmitting video of an entire law enforcement processing. The system includes a portable video storage device provided to be detachably worn on an arbitrary portion on a helmet, goggles, or a body of a law enforcement officer and is configured to store and manage first law enforcement information and to transmit the first law enforcement information. A vehicle-use video storage device is provided on a front and a rear portion of a police vehicle and is configured to compress second law enforcement information, store the compressed second law enforcement information, and transmit the first and second law enforcement information. The police station server generates law enforcement record information by combining the first law enforcement information and the first and second law enforcement information, stores and manages the law enforcement record information, and outputs indexed law enforcement record information.

### BACKGROUND OF THE INVENTION

1. Field of the Invention

The present invention relates, in general, to a system and method for transmitting video of an entire law enforcement processing, and, more particularly, to a system and method for transmitting video of an entire law enforcement processing, in which a portable video storage device is additionally provided along with a video storage device mounted in a police vehicle, so that video is captured in an entire law enforcement processing conducted by a police officer who conducts law enforcement, and is transmitted to a police station server, thus enabling the police station server to store and manage the video of the entire law enforcement processing and to utilize the video as an evidence of law enforcement.

2. Description of the Related Art

Typically, a law enforcement processing includes a series of actions conducted by the police to suppress and arrest a criminal suspect. Recently, accusations of excessive violence on the part of some police officers, in the name of self-defense, when conducting such law enforcement, have been made.

Recently, in the U.S., the backlash against law enforcement has increased in such a way that video captured at the scene of a law enforcement processing, such as the suppression and arrest of a criminal suspect conducted by some police officers lacking self-control, has been distributed over the Internet by human rights organizations.

In relation with this, a police organization in each area has introduced and operated a system for mounting a video recording device and an audio recording device on the front of a police vehicle and recording the conversation between police officer and criminal suspect throughout the law enforcement processing.

This system indicates measures for protecting the rights of a criminal suspect and improving the working efficiency of police officer related to law enforcement by recording the entire process in which a police vehicle, responding to a case, departs from a police station and arrives at the scene of a crime, and a police officer conducts law enforcement pertaining to a criminal suspect.

However, as shown in FIG. 1, the above system is inconvenient in that a video recording device and an audio recording device are limitedly installed only in police vehicles and operated thereby, and thus recording can only be limitedly performed along the moving track of a vehicle.

Further, since such a system has the weakness of being incapable of recording the scene of a crime, occurring inside a building or on a side street which a vehicle cannot enter, the system is disadvantageous in that the use of the system is limited only to roads along which a vehicle can travel, rather than the location of the entire law enforcement processing, and thus only some fragmentary actions are recorded.

### SUMMARY OF THE INVENTION

Accordingly, the present invention has been made keeping in mind the above problems occurring in the prior art, and an object of the present invention is to provide a system and method for transmitting video of an entire law enforcement processing, in which a portable video storage device, provided to be detachably worn on the helmet, goggles, shoulder or forearm of police officer, is additionally provided, in addition to a vehicle-use video storage device installed in a police vehicle when the police officer conducts a law enforcement processing, so that, even in an area in which the movement of the police vehicle is difficult, the entire law enforcement processing conducted by the police officer can be captured, and video captured in the entire law enforcement processing can be transmitted to a police station server and can be stored and managed therein.

In order to accomplish the above object, the present invention provides a system for transmitting video of an entire law enforcement processing, comprising a portable video storage device provided to be detachably worn on an arbitrary portion on a helmet, goggles, or a body of a law enforcement officer, including a shoulder or a forearm, and configured to store and manage first law enforcement information, which is generated by receiving location and time information through a Global Positioning System (GPS) satellite, recording conversation between the law enforcement officer and a criminal suspect, and capturing video in a law enforcement processing, and to transmit the generated first law enforcement information both to a vehicle-use video storage device and to a police station server, the vehicle-use video storage device provided on a front and a rear portion of a police vehicle and configured to compress second law enforcement information, which is generated by receiving location and time information through the GPS satellite, recording conversation content between the law enforcement officer and a criminal suspect, and capturing video in the law enforcement processing, for respective preset channels, to store the compressed second law enforcement information, and to transmit both the first law enforcement information and the second law enforcement information to the police station server, and the police station server configured to generate law enforcement record information by combining the first law enforcement information, received from the portable video storage device, and the first and second law enforcement information, received from the vehicle-use video storage device, to store and manage the law enforcement record information, and to output law enforcement record information indexed according to the location and time information.

Preferably, the portable video storage device comprises a first camera for capturing video in response to operation by the law enforcement officer, a first microphone unit for recording conversation content between the law enforcement officer and a criminal suspect and generating first recording information, a first GPS unit for reading real-time location information and current time information, included in a satellite signal received from the GPS satellite, and generating information about a location and time at which the video is currently being captured, a first memory unit for generating the first law enforcement information by combining the location and time information, the captured video and the first recording information, and storing the first law enforcement information, a first output unit for outputting the first law enforcement information stored in the first memory unit, the generated first law enforcement information being output in real time in response to operation by the law enforcement officer, a first radio transmission unit for transmitting the first law enforcement information to the vehicle-use video storage device through an information network, and a first control unit for supplying power to and controlling the first camera, the first microphone unit, the first GPS unit, the first memory unit, the first output unit, and the first radio transmission unit.

Preferably, the first memory unit is implemented as detachable Secure Digital card-type memory.

Preferably, the first output unit comprises a first screen display for outputting the video and the location and time information, included in the first law enforcement information, and a first speaker for outputting the recording information.

Preferably, the first radio transmission unit comprises a first high-speed mobile communication modem including a High Speed Downlink Packet Access (HSDPA) modem, High Speed Uplink Packet Access (HSUPA) modem, and an EVolution Data Only (EVDO) modem for providing asynchronous mobile communication and Wireless Broadband (WiBro), and the first radio transmission unit is configured to transmit the first law enforcement information to the police station server, which is located far away or in a remote place, in real time over the information network by way of the first high-speed mobile communication modem.

Preferably, the first radio transmission unit comprises a wireless transmitter including Wireless Fidelity (WiFi), ZigBee and Bluetooth, which enable near-field communication, and the first radio transmission unit is configured to transmit the first law enforcement information to the police station server, which is located far away or in a remote place, in real time over the information network by way of the wireless transmitter.

Preferably, the first control unit comprises a first internal battery provided in the first control unit and configured to supply charged power, and a first external battery connected to a power supply device provided in the vehicle through a power plug and configured to be supplied with power.

Preferably, the first control unit comprises a first external connection port including a USB port and a first AV port for transmitting the first law enforcement information, received from the first memory unit, to a monitor and a PC connected thereto.

Preferably, the vehicle-use video storage device comprises a second camera configured to capture video in response to operation by the law enforcement officer, and provided with a front camera mounted on a front window of the police vehicle to capture video, and a rear camera mounted on a rear portion of the police vehicle to capture video from rear seats inside the vehicle and an area behind the vehicle, a second microphone unit configured to record conversation content between the law enforcement officer and a criminal suspect and generate second recording information, a second GPS unit configured to read real-time location information and current time information, included in a satellite signal received from the GPS satellite, and generate information about a location and time at which the video is currently being captured, a second memory unit configured to generate the second law enforcement information by combining the location and time information, the captured video, and the second recording information, and compress and store the second law enforcement information for respective preset channels, a second output unit configured to output the second law enforcement information, stored in the second memory unit, and the first law enforcement information, which is received from the first radio transmission unit and is stored, the first law enforcement information and the second law enforcement information being output in real time in response to operation by the law enforcement officer, a second radio transmission unit configured to transmit the first and second law enforcement information, stored in the second memory unit, to the police station server through a third channel based on the information network, and transmit the first and second law enforcement information to the police station server in real time through a second high-speed mobile communication modem provided in the second radio transmission unit, and a second control unit configured to supply power to and control the second camera, the second microphone unit, the second GPS unit, the second memory unit, the second output unit, and the second radio transmission unit.

Preferably, the second memory unit may comprise a detachable compact flash card and a Hard Disc Drive (HDD), and is configured to compress the generated second law enforcement information for respective preset channels depending on a codec corresponding to the second law enforcement information, store the compressed second law enforcement information in a format of an FTP file, compress the first law enforcement information, received from the second radio transmission unit, and store the compressed first law enforcement information in a format of an FTP file, wherein the FTP file is a file in which the first and second law enforcement information is configured as metadata in a form of an Open Software Description (OSD).

Preferably, the second output unit comprises a second screen display for outputting the video and the location and time information, included in the first and second law enforcement information, and a second speaker for outputting recording information included in the first and second law enforcement information, wherein the first and second law enforcement information is decompressed and output.

Further, the present invention provides a method of transmitting video of an entire law enforcement processing, comprising a first step of a vehicle-use video storage device receiving location and time information through a Global Positioning System (GPS) satellite in response to operation by a law enforcement officer, and generating second law enforcement information on a basis of the location and time information, video captured in a law enforcement processing conducted by a law enforcement officer, and recording information, a second step of, when a law enforcement place of the law enforcement officer changes from a road to a side street or a building, a portable video storage device receiving location and time information through the GPS satellite in response to operation by the law enforcement officer, and generating first law enforcement information on a basis of the location and time information, video captured in a law enforcement processing conducted by the law enforcement officer, and recording information, a third step of the portable video storage device transmitting the generated first law enforcement information to the vehicle-use video storage device, and a fourth step of the vehicle-use video storage device transmitting both the generated second law enforcement information and the first law enforcement information, received from the portable video storage device, to a police station server.

Preferably, the method further comprises, after the first step, a fifth step of the vehicle-use video storage device outputting the second law enforcement information in real time, and outputting second law enforcement information stored in a second memory unit.

Preferably, the method further comprises, after the second step, a sixth step of the portable video storage device outputting the first law enforcement information in real time, and outputting first law enforcement information stored in a first memory unit.

Preferably, the method further comprises, after the fourth step, a seventh step of the police station server generating law enforcement record information on a basis of the first and second law enforcement information, and storing and managing the law enforcement record information, and an eighth step of indexing and outputting the law enforcement record information according to location and time information.

Preferably, the method according to claim 11, wherein the first step comprises the steps of providing the vehicle-use video storage device on a front and a rear portion of a police vehicle, capturing video in the law enforcement processing conducted by the law enforcement officer, and generating recording information by recording conversation, reading real-time location information and current time information, included in a satellite signal received from the GPS satellite, and generating information about a location and time at which the video is currently being captured, and generating the second law enforcement information on a basis of the location and time information, the captured video, and the recording information, compressing the second law enforcement information, and storing the compressed second law enforcement information in a format of an FTP file.

Preferably, the second step comprises the steps of providing the portable video storage device to be detachably worn on an arbitrary portion on a helmet, goggles, or a body of the law enforcement officer, including a shoulder or a forearm, capturing video in the law enforcement processing, and generating recording information by recording conversation, reading real-time location information and current time information, included in a satellite signal received from the GPS satellite, and generating information about a location and time at which the video is currently being captured, and generating the first law enforcement information on a basis of the location and time information, the captured video, and the recording information, compressing the first law enforcement information, and storing the compressed first law enforcement information in a format of an FTP file.

### BRIEF DESCRIPTION OF THE DRAWINGS

FIG. 1 is a diagram showing a conventional system for transmitting the video of a law enforcement processing;

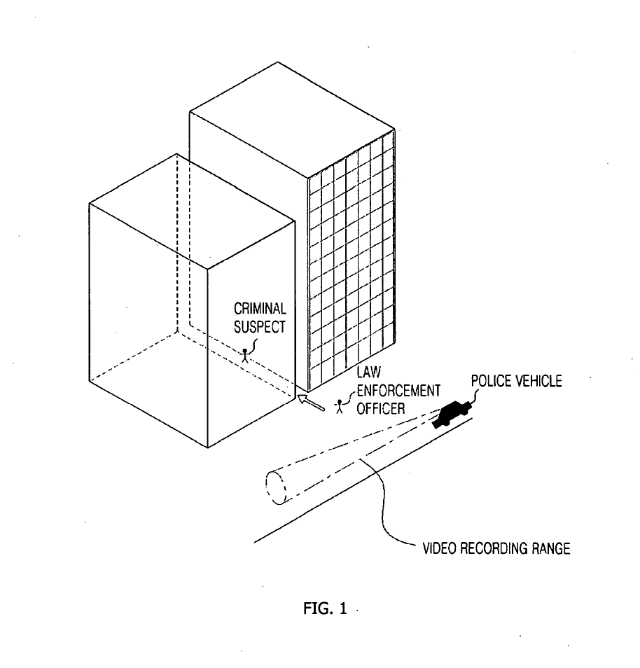

FIG. 2 is a diagram showing a system for transmitting video of an entire law enforcement processing according to the present invention;

FIG. 3 is a diagram showing the relationship between the components of the system for transmitting video of an entire law enforcement processing according to the present invention;

FIG. 4 is a diagram showing the detailed construction of the portable video storage device of the system for transmitting video of an entire law enforcement processing according to the present invention;

FIG. 5 is a diagram showing the detailed construction of the vehicle-use video storage device of the system for transmitting video of an entire law enforcement processing according to the present invention;

FIG. 6 is a flowchart showing a method of transmitting video of an entire law enforcement processing according to the present invention;

FIG. 7 is a flowchart showing fifth and sixth steps respectively performed after the first and second steps of the method of transmitting video of an entire law enforcement processing according to the present invention;

FIG. 8 is a flowchart showing seventh and eighth steps performed after the fourth step of the method of transmitting video of an entire law enforcement processing according to the present invention;

FIG. 9 is a flowchart showing the detailed steps of the first step of the method of transmitting video of an entire law enforcement processing according to the present invention; and

FIG. 10 is a flowchart showing the detailed steps of the second step of the method of transmitting video of an entire law enforcement processing according to the present invention.

### DESCRIPTION OF THE PREFERRED EMBODIMENTS

The detailed features and advantages of the present invention will be more clearly understood from the following detailed description taken in conjunction with the accompanying drawings. Before the description of the present invention, it should be noted that the terms or words used in the present specification and claims are to be interpreted as having meanings and concepts corresponding to the technical spirit of the present invention on the basis of the principle by which the inventor can suitably define the concept of terms to describe the invention thereof in the best way. In the following description of the present invention, detailed descriptions may be omitted if it is determined that the detailed descriptions of related well-known functions and construction may make the gist of the present invention unclear.

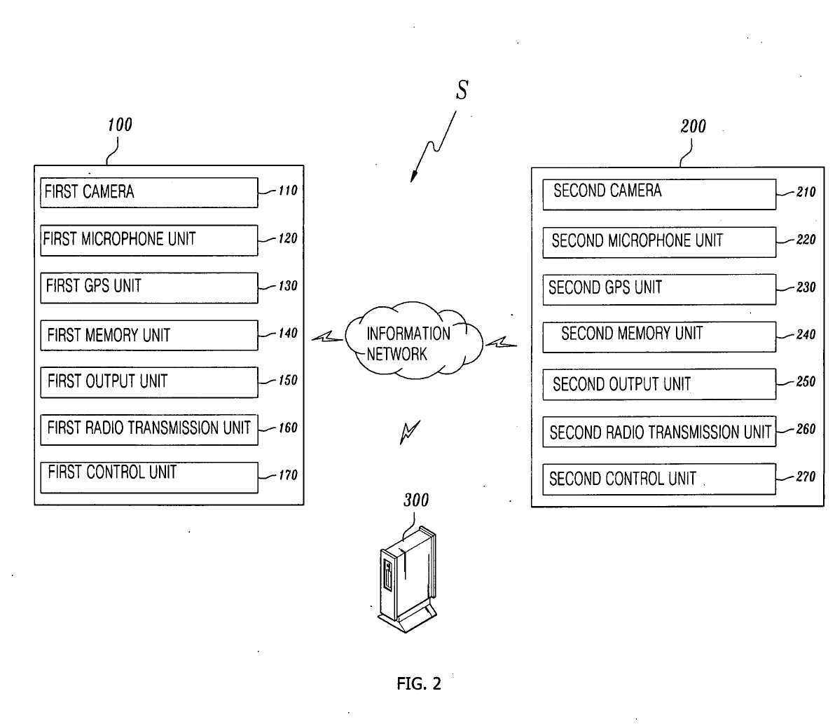

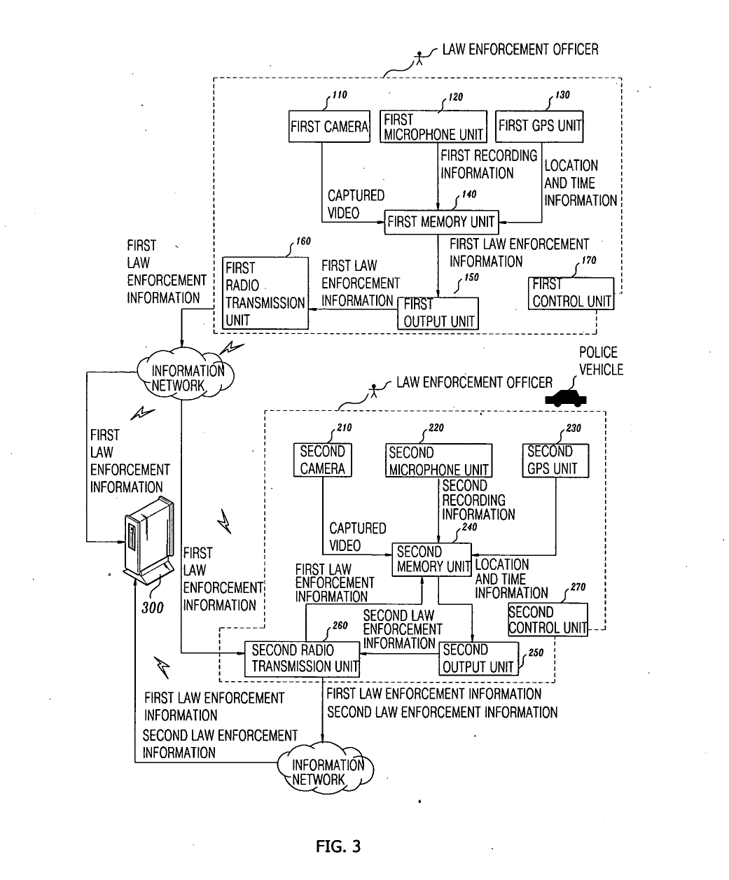

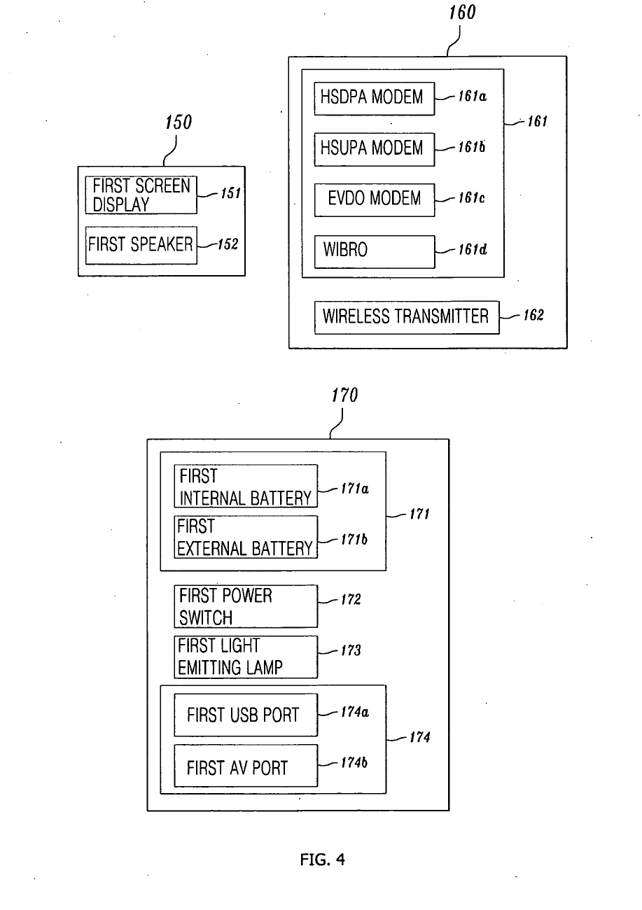

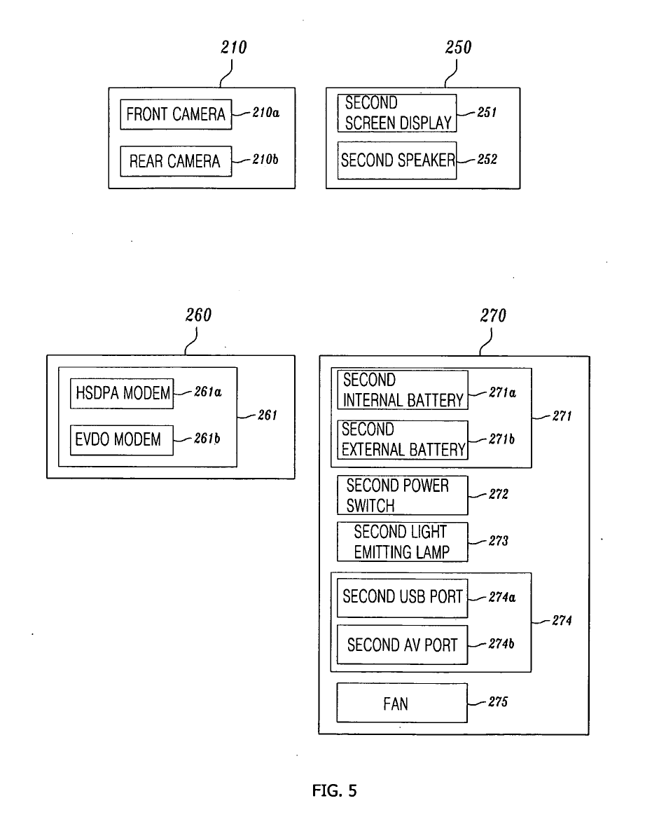

FIG. 2 is a diagram showing a system S for transmitting video of an entire law enforcement processing according to the present invention, FIG. 3 is a diagram showing the relationship between the components of the system for transmitting video of an entire law enforcement processing according to the present invention, FIG. 4 is a diagram showing the detailed construction of the portable video storage device 100 of the system for transmitting video of an entire law enforcement processing according to the present invention, and FIG. 5 is a diagram showing the detailed construction of the vehicle-use video storage device 200 of the system for transmitting video of an entire law enforcement processing according to the present invention.

As shown in FIG. 2, the system S for transmitting video of an entire law enforcement processing according to the present invention includes a portable video storage device 100, a vehicle-use video storage device 200, and a police station server 300.

Although a detailed description thereof is omitted, the transmission or reception of data between the portable video storage device 100, the vehicle-use video storage device 200, and the police station server 300 is performed through an information network. Such an information network is assumed to include a Transmission Control protocol/Internet Protocol (TCP/IP) communication channel, a Radio Frequency Identification (RFID) reader/writer, an infrared communication channel, a Bluetooth communication channel, and a near-field communication channel (ZigBee).

Further, the law enforcement processing of the present invention includes all activities related to the execution of police officers' official duties, such as the arrest of a criminal suspect, the regulation of a speeding vehicle or an overloaded vehicle, the regulation of illegally parked/stopped vehicles, and the regulation of drunken drivers.

The portable video storage device 100 is provided to be detachably worn on an arbitrary portion on the helmet or the goggles of a law enforcement officer, or the body of the police officer, including the shoulder or forearm. The portable video storage device 100 functions to store first law enforcement information, generated by receiving location and time information through a Global Positioning System (GPS) satellite, by recording the conversation between the law enforcement officer and a criminal suspect, and by capturing video in the law enforcement processing, and to transmit the generated first law enforcement information both to the vehicle-use video storage device 200 and to the police station server 300. The portable video storage device 100 includes a first camera 110, a first microphone unit 120, a first GPS unit 130, a first memory unit 140, a first output unit 150, a first radio transmission unit 160, and a first control unit 170.

In detail, referring to FIG. 3, the first camera 110 captures video through the operation of a law enforcement officer, and the first microphone unit 120 records the conversation between the law enforcement officer and a criminal suspect and generates first recording information.

The first GPS unit 130 generates information about the location and time at which video is currently being captured by reading real-time location information and current time information, included in a satellite signal received from the GPS satellite.

The first memory unit 140 generates the first law enforcement information on the basis of the location and time information, the captured video, and the first recording information, which are received in real time from the first GPS unit 130, the first camera 110, and the first microphone unit 120, and stores the first law enforcement information. In this case, the first memory unit 140 is provided in the portable video storage device 100 and is configured to store and manage the first law enforcement information, but may be implemented as detachable Secure Digital (SD) card-type memory.

The first output unit 150 outputs the first law enforcement information, stored in the first memory unit 140, so that the first law enforcement information is output in real time through the operation of the law enforcement officer. As shown in FIG. 4, the first output unit 150 includes a first screen display 151 for outputting the captured video and the location and time information, included in the first law enforcement information, and a first speaker 152 for outputting the recording information.

The first radio transmission unit 160 transmits the first law enforcement information, stored in the first memory unit 140, to the vehicle-use video storage device 200 through the information network.

Further, as shown in FIG. 4, the first radio transmission unit 160 includes a first high-speed mobile communication modem 161, including a High Speed Downlink Packet Access (HSDPA) modem 161a, HSUPA modem 161b, and an EVolution Data Only (EVDO) modem 161c for providing asynchronous mobile communication and Wireless Broadband (WiBro) 161d, thus directly transmitting the first law enforcement information to a police station server 300 located far away or in a remote place.

The first radio transmission unit 160 may further include a wireless transmitter 162 including Wireless Fidelity (WiFi), ZigBee and Bluetooth, which enable near-field communication.

The first control unit 170 controls the above components, that is, the first camera 110, the first microphone unit 120, the first GPS unit 130, the first memory unit 140, the first output unit 150, and the first radio transmission unit 160 in response to operation by the law enforcement officer, and includes a first battery 171 for supplying power to the components. The first battery 171 includes a first internal battery 171a, which is provided therein to supply charged power, and a first external battery 171b, which is connected to a power supply device provided in a vehicle via a power plug and is supplied with power.

As shown in FIG. 4, the first control unit 170 further includes a first power switch 172 for controlling the ON/OFF operation of power, and a first light emitting lamp 173 for indicating whether an operation is performed depending on the supply of power.

The first control unit 170 further includes a first external connection port 174 including a first USB port 174a and a first AV port 174b for transmitting the first law enforcement information received from the first memory unit 140 both to a monitor and a Personal Computer (PC) connected thereto.

Meanwhile, the vehicle-use video storage device 200 is provided on the front and rear portion of a police vehicle and functions to compress second law enforcement information, generated by receiving the location and time information through the GPS satellite, by recording the conversation between the law enforcement officer and a criminal suspect and by capturing video in a law enforcement processing, for respective preset channels, to store the second law enforcement information, and to transmit the second law enforcement information to the police station server 300. The vehicle-use video storage device 200 includes a second camera 210, a second microphone unit 220, a second GPS unit 230, a second memory unit 240, a second output unit 250, a second radio transmission unit 260, and a second control unit 270.

In detail, referring to FIGS. 3 and 5, the second camera 210 captures video through the operation of a law enforcement officer, and includes a front camera 210a provided on the front window of a police vehicle to capture video, and a rear camera 210b provided on the rear portion of the police vehicle to capture video from rear seats inside of the vehicle and an area behind the vehicle.

The second microphone unit 220 generates recording information by recording the conversation between the law enforcement officer and a criminal suspect. The second GPS unit 230 generates information about the location and time at which video is currently being captured by reading real-time location information and current time information, included in a satellite signal received from the GPS satellite.

The second memory unit 240 generates second law enforcement information by combining the location and time information, the captured video and the recording information, which are received in real time from the second GPS unit 230, the second camera 210, and the second microphone unit 220, compresses the second law enforcement information for respective preset channels depending on a codec corresponding to the second law enforcement information, stores the compressed information in the format of a File Transfer Protocol (FTP) file, compresses the first law enforcement information, received from the second radio transmission unit 260, and stores the compressed information in the format of an FTP file.

The term ‘FTP file’ means a file in which the first and second law enforcement information is configured as metadata in the form of an Open Software Description (OSD).

Further, the channels are connected to the information network, and are implemented to have three or more channels. The first channel is connected to the front camera 210a in a wired manner, the second channel is connected to the rear camera 210b in a wired manner, and the third channel is connected in a wireless manner to both the second radio transmission unit 260 and the police station server 300, which receive the first law enforcement information from the portable video storage device 100.

Further, the second memory unit is provided in the vehicle-use video storage device and is configured to compress and store the first and second law enforcement information. However, the second memory unit is not limited to this structure, and may be implemented as external memory having the form of a detachable compact flash card or a Hard Disc Drive (HDD).

The second output unit 250 outputs both the second law enforcement information, stored in the second memory unit 240, and the first law enforcement information, which is received from the first radio transmission unit 160 and is stored. In this case, both the first law enforcement information and the second law enforcement information are output in real time through the operation of a law enforcement officer. As shown in FIG. 5, the second output unit 250 includes a second screen display 251 for outputting the captured video and the location and time information, included in the first and second law enforcement information, and a second speaker 252 for outputting the recording information. In this case, the output is performed by decompressing the first and second law enforcement information, received from the second memory unit 240.

The second radio transmission unit 260 transmits the first and second law enforcement information, stored in the second memory unit 240, to the police station server 300 through a third channel based on the information network. As shown in FIG. 5, the first and second law enforcement information is transmitted in real time to the police station server 300 through a second high-speed mobile communication modem 261, including an HSDPA modem 261a and an EVDO modem 261b provided therein.

The second control unit 270 controls the above components, that is, the second camera 210, the second microphone unit 220, the second GPS unit 230, the second memory unit 240, the second output unit 250 and the second radio transmission unit 260, in response to operation by the law enforcement officer, and includes a second battery 271 for supplying power to the above components. The second battery 171 includes a second internal battery 271a, which is provided therein to supply charged power, and a second external battery 271b, which is connected to the battery of a police vehicle via a power plug and is supplied with power.

Further, as shown in FIG. 5, the second control unit 270 includes a second power switch 272 for controlling the ON/OFF operation of power, and a second light emitting lamp 273 for indicating whether an operation is performed depending on the supply of power, and further includes a second external connection port 274 including a second USB port 274a and an AUX port 274b for transmitting the first and second law enforcement information, received from the second memory unit 240, to a display monitor, a PC and an audio player, which are connected to the second external connection port.

The second control unit 270 may further include a fan 275 for decreasing a temperature that increases due to the generation of heat as the vehicle-use video storage device 200 is operated for a predetermined period of time.

Meanwhile, the police station server 300 receives the first law enforcement information from the portable video storage device 100, and the first and second law enforcement information from the vehicle-use video storage device 200, generates law enforcement record information by combining the received law enforcement information, stores and manages the law enforcement record information, and outputs law enforcement record information indexed according to location and time information.

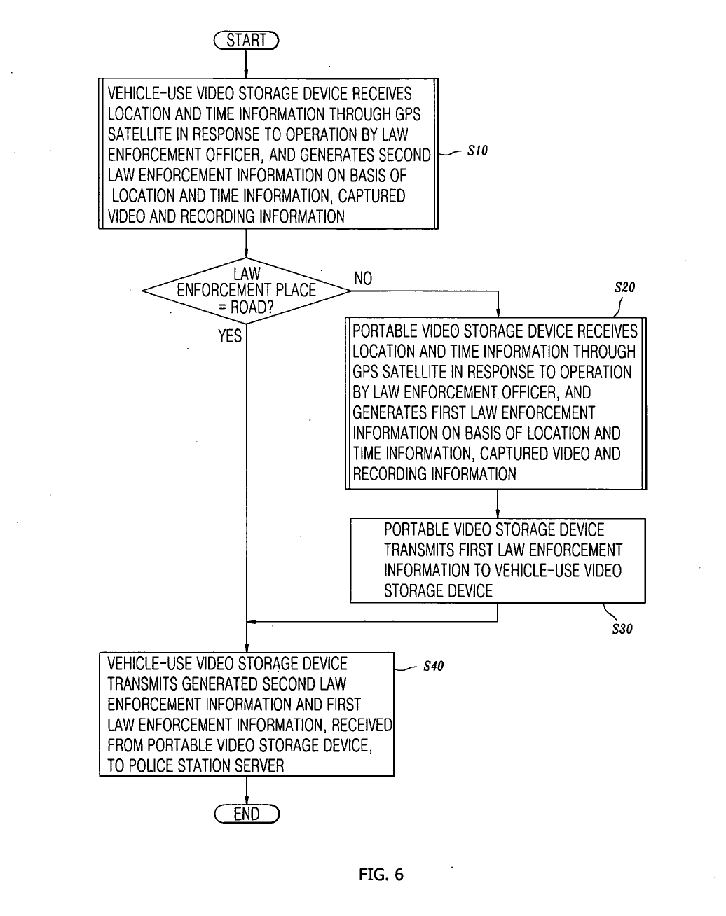

A method of transmitting video using the above-described system S for transmitting video of an entire law enforcement processing according to the present invention will be described in detail with reference to FIGS. 6 to 10.

As shown in FIG. 6, the vehicle-use video storage device 200 receives location and time information through a GPS satellite in response to operation by a law enforcement officer, and generates second law enforcement information on the basis of the video, captured in a law enforcement processing conducted by the law enforcement officer, and recording information at step S10.

Next, when a police vehicle required for law enforcement moves from a road, that is, when the place, at which law enforcement is conducted by a law enforcement officer, changes from the road to a side street or a building , the portable video storage device 100 receives location and time information through the GPS satellite in response to operation by the law enforcement officer, and generates first law enforcement information on the basis of the location and time information, the video captured in the law enforcement processing conducted by the law enforcement officer, and the recording information at step S20.

Thereafter, the portable video storage device 100 transmits the generated first law enforcement information to the vehicle-use video storage device 200 at step S30. The vehicle-use video storage device 200 transmits both the generated second law enforcement information and the first law enforcement information, received from the portable video storage device 100, to the police station server 300 at step S40.

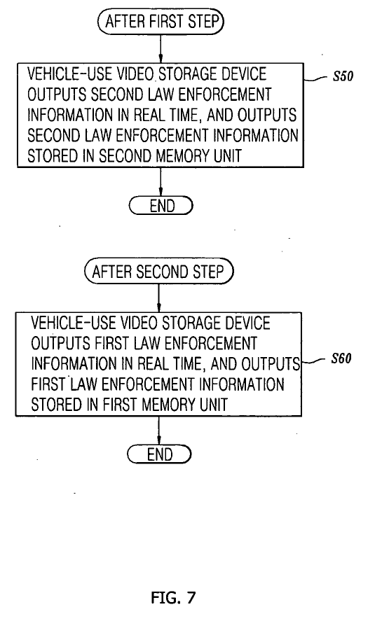

Further, as shown in FIG. 7, after step S10, the vehicle-use video storage device 200 may output the second law enforcement information in real time, or may output the second law enforcement information stored in the second memory unit at step S50.

Further, after step S20, the portable video storage device 100 may output the first law enforcement information in real time, or may output the first law enforcement information stored in the first memory unit at step S60.

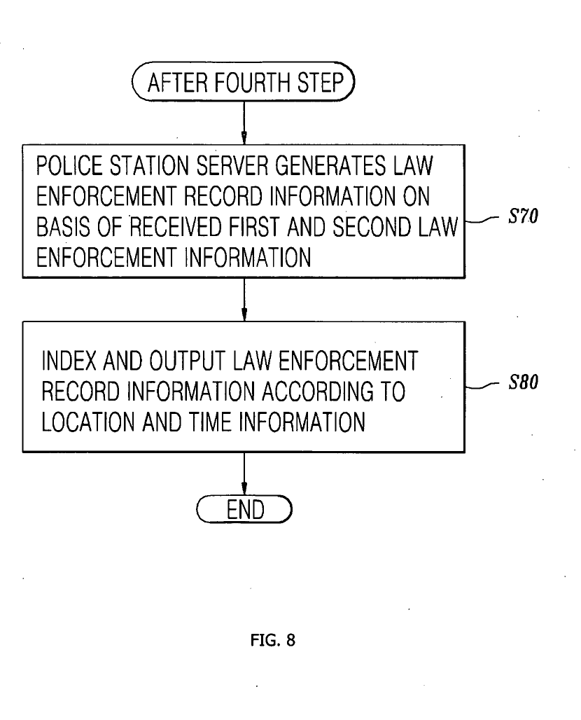

Further, as shown in FIG. 8, after step S40, the police station server 300 generates law enforcement record information by combining the received first and second law enforcement information, and stores and manages the law enforcement record information at step S70. The police station server 300 indexes and outputs the law enforcement record information according to the location and time information at step S80.

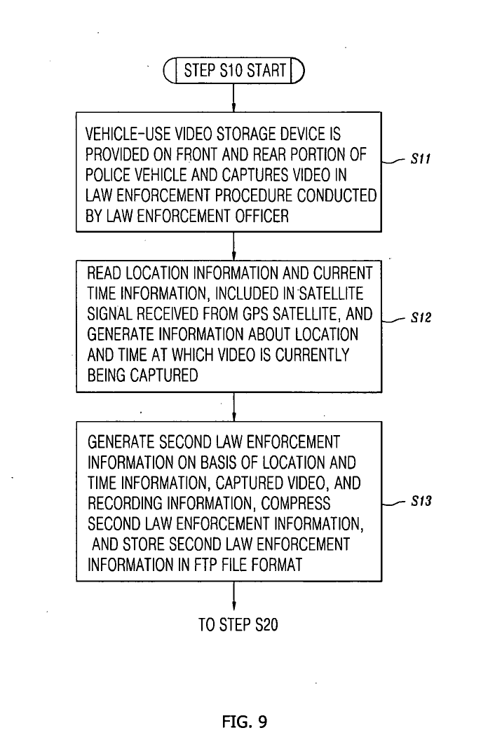

In detail, step S10 is described in detail with reference to FIG. 9. Step S10 includes the step S11 of providing the vehicle-use video storage device on the front and rear portion of the police vehicle, capturing video of the law enforcement processing conducted by the law enforcement officer, and generating recording information by recording the conversation, the step S12 of reading real-time location information and current time information, included in a satellite signal received from the GPS satellite, and generating information about the location and time at which video is currently being captured, and the step S13 of generating second law enforcement information on the basis of the location and time information, the captured video, and the recording information, compressing the second law enforcement information, and storing the compressed second law enforcement information in the format of an FTP file.

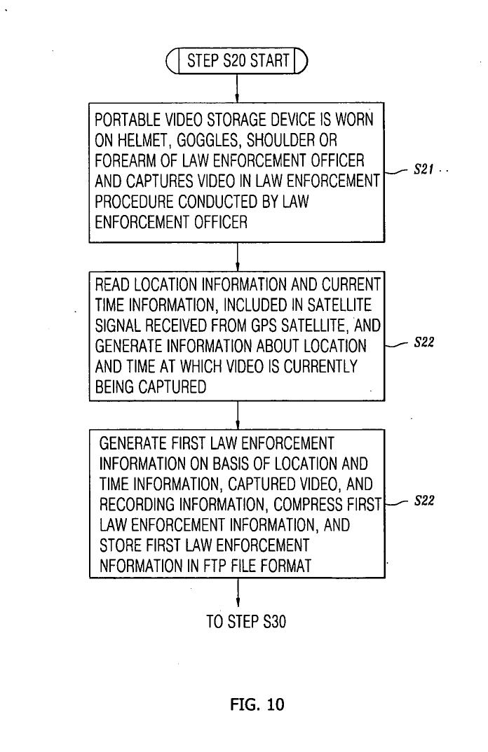

Further, step S20 is described in detail with reference to FIG. 10. Step S20 includes the step S21 of providing the portable video storage device to be worn on the helmet, goggles, shoulder or forearm of the law enforcement officer, capturing video in the law enforcement processing, and generating recording information by recording the conversation, the step S22 of reading real-time location information and current time information, included in a satellite signal received from the GPS satellite, and generating information about the location and time at which video is currently being captured, and the step S23 of generating first law enforcement information on the basis of the location and time information, the captured video, and the recording information, compressing the first law enforcement information, and storing the compressed first law enforcement information in the format of an FTP file.

According to the present invention, there are advantages in that, when a police officer conducts a law enforcement processing, the law enforcement processing conducted by the police officer is captured through a vehicle-use video storage device mounted in a police vehicle, and a law enforcement processing, conducted in an area in which it is difficult for the police vehicle to travel, is captured by a portable video storage device provided to be detachably worn on an arbitrary portion on the helmet, goggles or the body of the police officer, including the shoulder or forearm, thus enabling the entire law enforcement processing to be captured without being limited by the place where a police officer conducts law enforcement.

Further, the present invention is advantageous in that a police station server can receive video related to law enforcement, which has been captured or is currently being captured, thus enabling the control of a law enforcement officer.

In addition, the present invention is advantageous in that video of the entire law enforcement processing, which is received from a vehicle-use video storage device and a portable video storage device, can be indexed according to location and time information and can be recorded, stored and managed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Therefore, all suitable changes, modifications and equivalents thereof should be interpreted as being included in the scope of the present invention.

What is claimed is:

1. A system for transmitting video of an entire law enforcement processing, comprising:
a portable video storage device provided to be detachably worn on an arbitrary portion on a helmet, goggles, or a body of a law enforcement officer, including a shoulder or a forearm, and configured to store and manage first law enforcement information, which is generated by receiving location and time information through a Global Positioning System (GPS) satellite, recording conversation between the law enforcement officer and a criminal suspect, and capturing video in a law enforcement processing, and to transmit the generated first law enforcement information both to a vehicle-use video storage device and to a police station server;
the vehicle-use video storage device provided on a front and a rear portion of a police vehicle and configured to compress second law enforcement information, which is generated by receiving location and time information through the GPS satellite, recording conversation content between the law enforcement officer and a criminal suspect, and capturing video in the law enforcement processing, for respective preset channels, to store the compressed second law enforcement information, and to transmit both the first law enforcement information and the second law enforcement information to the police station server; and
the police station server configured to generate law enforcement record information by combining the first law enforcement information, received from the portable video storage device, and the first and second law enforcement information, received from the vehicle-use video storage device, to store and manage the law enforcement record information, and to output law enforcement record information indexed according to the location and time information.

2. The system according to claim 1, wherein the portable video storage device comprises:
a first camera for capturing video in response to operation by the law enforcement officer;
a first microphone unit for recording conversation content between the law enforcement officer and a criminal suspect and generating first recording information;
a first GPS unit for reading real-time location information and current time information, included in a satellite signal received from the GPS satellite, and generating information about a location and time at which the video is currently being captured;
a first memory unit for generating the first law enforcement information by combining the location and time information, the captured video and the first recording information, and storing the first law enforcement information;
a first output unit for outputting the first law enforcement information stored in the first memory unit, the generated first law enforcement information being output in real time in response to operation by the law enforcement officer;
a first radio transmission unit for transmitting the first law enforcement information to the vehicle-use video storage device through an information network; and
a first control unit for supplying power to and controlling the first camera, the first microphone unit, the first GPS unit, the first memory unit, the first output unit, and the first radio transmission unit.

3. The system according to claim 2, wherein the first memory unit is implemented as detachable Secure Digital card-type memory.

4. The system according to claim 2, wherein the first output unit comprises:
a first screen display for outputting the video and the location and time information, included in the first law enforcement information; and
a first speaker for outputting the recording information.

5. The system according to claim 2, wherein:
the first radio transmission unit comprises a first high-speed mobile communication modem including a High Speed Downlink Packet Access (HSDPA) modem, a High Speed Uplink Packet Access (HSUPA) modem, and an EVolution Data Only (BVDO) modem for providing asynchronous mobile communication and Wireless Broadband (Wibro), and
the first radio transmission unit is configured to transmit the first law enforcement information to the police station server, which is located far away or in a remote place, in real time over the information network by way of the first high-speed mobile communication modem.

6. The system according to claim 2, wherein:
the first radio transmission unit comprises a wireless transmitter including Wireless Fidelity (WiFi), ZigBee, and Bluetooth, which enable near-field communication, and
the first radio transmission unit is configured to transmit the first law enforcement information to the police station server, which is located far away or in a remote place, in real time over the information network by way of the wireless transmitter.

7. The system according to claim 2, wherein the first control unit comprises:
a first internal battery provided in the first control unit and configured to supply charged power; and
a first external battery connected to a power supply device provided in the vehicle through a power plug and configured to be supplied with power.

8. The system according to claim 2, wherein the first control unit comprises a first external connection port including a USB port and a first AV port for transmitting the first law enforcement information, received from the first memory unit, to a monitor and a PC connected thereto.

9. The system according to claim 1, wherein the vehicle-use video storage device comprises:
a second camera configured to capture video in response to operation by the law enforcement officer, and provided with a front camera mounted on a front window of the police vehicle to capture video, and a rear camera mounted on a rear portion of the police vehicle to capture video from rear seats inside the vehicle and an area behind the vehicle;
a second microphone unit configured to record conversation content between the law enforcement officer and a criminal suspect and generate second recording information;
a second GPS unit configured to read real-time location information and current time information, included in a satellite signal received from the GPS satellite, and generate information about a location and time at which the video is currently being captured;
a second memory unit configured to generate the second law enforcement information by combining the location and time information, the captured video, and the second recording information, and compress and store the second law enforcement information for respective preset channels;
a second output unit configured to output the second law enforcement information, stored in the second memory unit, and the first law enforcement information, which is received from the first radio transmission unit and is stored, the first law enforcement information and the second law enforcement information being output in real time in response to operation by the law enforcement officer;
a second radio transmission unit configured to transmit the first and second law enforcement information, stored in the second memory unit, to the police station server through a third channel based on the information network, and transmit the first and second law enforcement information to the police station server in real time through a second high-speed mobile communication modem provided in the second radio transmission unit; and
a second control unit configured to supply power to and control the second camera, the second microphone unit, the second GPS unit, the second memory unit, the second output unit, and the second radio transmission unit.

10. The system according to claim 9, wherein:
the second memory unit comprises a detachable compact flash card and a Hard Disc Drive (HDD), and is configured to compress the generated second law enforcement information for respective preset channels depending on a codec corresponding to the second law enforcement information, store the compressed second law enforcement information in a format of a File Transfer Protocol (FTP) file, compress the first law enforcement information, received from the second radio transmission unit, and store the compressed first law enforcement information in a format of an FTP file, and
the FTP file is a file in which the first and second law enforcement information is configured as metadata in a form of an Open Software Description (OSD).

11. The system according to claim 9, wherein the second output unit comprises:
a second screen display for outputting the video and the location and time information, included in the first and second law enforcement information; and
a second speaker for outputting recording information included in the first and second law enforcement information,
wherein the first and second law enforcement information is decompressed and output.

12. A method of transmitting video of an entire law enforcement processing, comprising:
a first step of a vehicle-use video storage device receiving location and time information through a Global Positioning System (GPS) satellite in response to operation by a law enforcement officer, and generating second law enforcement information on a basis of the location and time information, video captured in a law enforcement processing conducted by a law enforcement officer, and recording information;
a second step of, when a law enforcement place of the law enforcement officer changes from a road to a side street or a building, a portable video storage device receiving location and time information through the GPS satellite in response to operation by the law enforcement officer, and generating first law enforcement information on a basis of the location and time information, video captured in a law enforcement processing conducted by the law enforcement officer, and recording information;
a third step of the portable video storage device transmitting the generated first law enforcement information to the vehicle-use video storage device; and
a fourth step of the vehicle-use video storage device transmitting both the generated second law enforcement information and the first law enforcement information, received from the portable video storage device, to a police station server.

13. The method according to claim 12, further comprising, after the first step, a fifth step of the vehicle-use video storage device outputting the second law enforcement information in real time, and outputting second law enforcement information stored in a second memory unit.

14. The method according to claim 12, further comprising, after the second step, a sixth step of the portable video storage device outputting the first law enforcement information in real time, and outputting first law enforcement information stored in a first memory unit.

15. The method according to claim 12, further comprising, after the fourth step:
a seventh step of the police station server generating law enforcement record information on a basis of the first and second law enforcement information, and storing and managing the law enforcement record information; and
an eighth step of indexing and outputting the law enforcement record information according to location and time information.

16. The method according to claim 12, wherein the first step comprises the steps of:
providing the vehicle-use video storage device on a front and a rear portion of a police vehicle, capturing video in the law enforcement processing conducted by the law enforcement officer, and generating recording information by recording conversation;
reading real-time location information and current time information, included in a satellite signal received from the GPS satellite, and generating information about a location and time at which the video is currently being captured; and
generating the second law enforcement information on a basis of the location and time information, the captured video, and the recording information, compressing the second law enforcement information, and storing the compressed second law enforcement information in a format of an FTP file.

17. The method according to claim 12, wherein the second step comprises the steps of:
providing the portable video storage device to be detachably worn on an arbitrary portion on a helmet, goggles, or a body of the law enforcement officer, including a shoulder or a forearm, capturing video in the law enforcement processing, and generating recording information by recording conversation;
reading real-time location information and current time information, included in a satellite signal received from the GPS satellite, and generating information about a location and time at which the video is currently being captured; and
generating the first law enforcement information on a basis of the location and time information, the captured video, and the recording information, compressing the first law enforcement information, and storing the compressed first law enforcement information in a format of an FTP file.
